(19) United States
(12) Patent Application Publication
(10) Pub. No.: US 2026/0284547 A1
(43) Pub. Date: Sep. 24, 2026

(54) INTERFACIAL EVAPORATION DEVICE FOR EVAPORATION PONDS

(71) Applicant: Saudi Arabian Oil Company, Dhahran (SA)

(72) Inventors: Sarah Almahfoodh, Anak (SA); Seung-Hak Choi, Incheon (KR); Abdulaziz Y. AlAmmar, Dammam (SA); Arwa Alluqman, Al Khobar (SA)

(21) Appl. No.: 19/087,993

(22) Filed: Mar. 24, 2025

(51) Int. Cl. B01D 1/00; C02F 1/04; C02F 1/14; C02F 103/10

(52) U.S. Cl. CPC B01D 1/0064; B01D 1/0005; B01D 1/0035; C02F 1/048; C02F 1/14; C02F 2103/10; C02F 2209/42

(57) ABSTRACT

An interfacial evaporation device for evaporation ponds includes a floating hydrophobic member configured to float at a surface of the body of water. A membrane is disposed on a surface of the floating hydrophobic member. The membrane defines an evaporation surface of the device for receiving solar energy. A wick is connected to the membrane and extends through the floating hydrophobic member. The wick is configured to extend into the body of water and draw water from the body of water and direct the drawn water to the membrane. The membrane is configured to transfer at least a portion of the received solar energy to the drawn water directed to the membrane by the wick to evaporate the drawn water, thereby decreasing a water content of the body of water.

### TECHNICAL FIELD

This disclosure relates to processing wastewater in evaporation ponds.

### BACKGROUND

Evaporation ponds are large, shallow pools that utilize sunlight and wind for water evaporation. Evaporation ponds are used across various industries due to their ease of construction and operation. For example, in oil and mining operations, an evaporation pond can concentrate contaminated wastewater, thereby reducing its volume for treatment. In another example, evaporation ponds are used in agriculture to manage water drainage, thereby preventing salinization of freshwater sources. Evaporation ponds can also be utilized in desalination as brine management tools for in-land desalination plants and in salt production and mineral recovery.

Evaporation ponds rely on atmospheric conditions such as humidity, sunlight, wind, and temperature, thereby making the evaporation and concentration processes slow in areas with low wind or sunlight. In addition, evaporation ponds often require large surface area for efficient operation. In addition, contaminated water, such as industrial or oily waters, include floater particles and substances. Such particles and substances form a layer over the water, thereby preventing sunlight from effectively heating the water. The capacity of an evaporation pond is limited, thereby increasing vulnerability to overflow due to operational or seasonal variations.

### SUMMARY

This disclosure describes technologies relating to interfacial evaporation devices for evaporation ponds.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an evaporation pond deploying an interfacial evaporation device.

FIG. 2 is a schematic diagram of the interfacial evaporation device of FIG. 1 with a micro-patterned surface.

FIG. 3 is a schematic diagram of the interfacial evaporation device of FIG. 1 with a membrane coating.

FIG. 4 is a schematic diagram of an evaporation pond deploying another implementation of an interfacial evaporation device.

FIG. 5 is a flowchart of an example of a process of using an interfacial evaporation device in an evaporation pond.

### DETAILED DESCRIPTION

This disclosure describes an interfacial evaporation device for enhancing evaporation efficiency of evaporation ponds. The device integrates material and engineering modifications into a single device. The device includes a floating hydrophobic phase, a wick, and a membrane. The membrane rests on top of the floating hydrophobic phase, and the wick goes through the floating hydrophobic phase to connect to the membrane. The membrane provides the evaporation surface of the device. The floating hydrophobic phase provides flotation and thermal insulation, which focuses heat on the membrane. The wick delivers water from the body of water to the membrane. The membrane and wick can be hydrophilic.

The device can be implemented in bodies of water to improve evaporation from such bodies of water and provide one or more of the following benefits: reducing pond footprint requirements for new ponds, improving evaporation for ponds with a wide range of water compositions, free of requiring moving parts and input of energy to improve evaporation, and recovering water and minerals from ponds. In some implementations, the membrane can have a micro-patterned surface to increase surface area for further increasing evaporation rate. The device can also improve concentration of different wastewater streams in the evaporation pond, such as produced water, sour recovery unit wastewater, CPI outlet, to name a few.

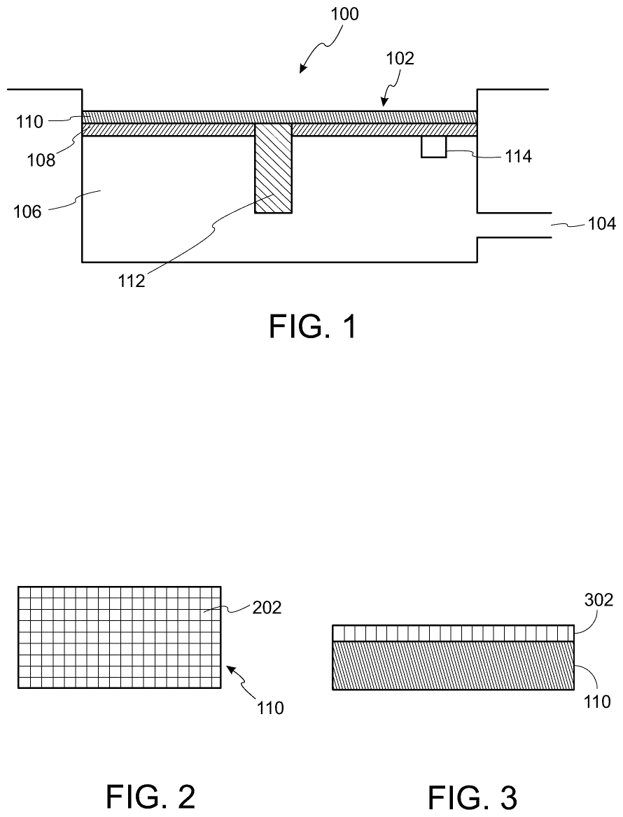

FIG. 1 is a schematic diagram of an evaporation pond 100 deploying an interfacial evaporation device 102. An evaporation pond 100 is a shallow, man-made pit in the surface of the Earth to receive water. In this disclosure, certain implementations of evaporation ponds that receive wastewater from wells, for example, hydrocarbon producing wells, are described. However, the interfacial evaporation device described in this disclosure can be deployed in evaporation ponds built to hold water from other sources as well. Such sources can include, for example, oceans, seas, lakes, rivers, wastewater from processing plants (such as Gas Oil Separation Plants), produced water, industrial water, brine or textile water. In the schematic diagram shown in FIG. 1, the evaporation pond 100 receives wastewater through an inlet 104 connected to a producing well (not shown). The inlet 104 can be above or below the surface of the Earth. In implementations in which the inlet is above the surface of the Earth, the interfacial evaporation device 102 may not cover the entire surface of the evaporation pond 100, but instead may cover a portion (e.g., most of) the surface with the inlet to allow the water to be received within the evaporation pond 100. Water 106 flowed through the inlet fills the evaporation pond 100.

The interfacial evaporation device 102 includes a member 108 that can float on a surface of the water 106 in the evaporation pond 100. In some implementations, the member 108 can be a single structure that has a surface area that is large enough to cover substantially an entire surface of the water 106 in the evaporation pond 100. In some implementations, the interfacial evaporation device 102 can include multiple members, each having a surface area to cover a portion of the surface of the water 106. Multiple such members together can be deployed to cover the entire surface of the water 106. The member 108 is hydrophobic and can repel water away from itself. By doing so, the member 108 ensures that the member 108 and any other structure attached to the member 108 remains at the surface of the water 106. In addition, the member 108 can be made of or can be covered by an insulating material that can focus on retrieval of solar energy onto the membrane 108 while preventing a majority of the solar energy from being transferred through to the body of water below.

The interfacial evaporation device 102 includes a membrane 110 disposed on a surface of the member 108. The membrane 110 defines an evaporation surface of the interfacial evaporation device 102 for receiving solar energy. In some implementations, the membrane 110 is planar with a surface area equal to that of the member 108. When the membrane 110 is disposed on a surface of the member 108, the membrane 110 can cover an entirety of the surface of the member 108. When deployed in an evaporation pond 100, the member 108 is in immediate contact with the water 106. The membrane 110 resides above the member 108 such that the member 108 is between the membrane 110 and the surface of the water 106. The membrane 110 is hydrophilic and attracts water to itself. In some implementations, the membrane 110 is one of a Janus membrane, an omniphobic membrane or an oleophobic membrane. For example, hydrophilic membranes are suitable for aqueous phases. In ponds in which oily/organic phase is present, oleo-or omni-phobic membranes can present longer lifetime and performance stability.

In some implementations, the membrane 110 includes a micro-patterned surface. FIG. 2 is a schematic diagram of the interfacial evaporation device of FIG. 1 with the micro-patterned surface 202. The micro-patterned surface (such as the surface 202) increases a surface area for evaporation. The micro-patterned surface is arranged on the membrane 110 such that the surface is exposed to the sun. The micro-patterned surface can be formed by depositing photothermal materials on the surface, e.g., by coating, cross-linking or vacuum filtration.

The dimensions of the pattern can be in the micrometer range (e.g., between 1 micrometer and 100 micrometers). The patterns can be formed during coating process. For planar geometry, for example, just after coating (e.g., slot-die coating), the coated membrane can pass through a press roller before drying. The roller surface can have a mesh type pattern on the surface to press the undried membrane surface and then dry. The surface area can be high for enhanced evaporation. For example, the evaporation rate can be expressed as area-normalized flow rate (i.e., flux). The surface area can be sufficient to result in an evaporation rate having a flux greater than 0.5 kg/m²/h, which is the highest flux achievable in conventional evaporation ponds.

In some implementations, the membrane 110 has a coating on a surface exposed to the sun. FIG. 3 is a schematic diagram of the interfacial evaporation device of FIG. 1 with a membrane coating 302. The coating (such as the coating 302) can include a photothermal material that can absorb sunlight and increase a temperature of the membrane 110. For example, the coating can include carbon (e.g., graphene, graphite, carbon black), a metal or a metal oxide (e.g., gold, silver, iron), a polymer (e.g., polypyrrole, polydopamine, polyaniline, poly(ethylenedioxythiophene): polystyrene (PEDOT:PSS) or combinations of them.

In some implementations, the membrane can be coated through slot-die coating, particularly for planar geometries. Spin coating is another example of a simple, low-cost method to apply coating layer on top of a flat surface. In spin coating, the substrate size can be limited depending on the spin coater size. Tubular geometry membranes can be coated by phase inversion spinning process or dip coating. In phase inversion spinning process, coating material and polymeric material are mixed to make a homogeneous solution using solvent or heat. The solution is then extruded through a spinneret to induce phase separation followed by membrane solidification. In dip coating, the substrate is immersed into a solution containing material material and withdrawn at constant speed. The coating speed, concentration of coating solution and ambient temperature determine the coating thickness. In some implementations, the coating can include an ultraviolet resistant material to protect the membrane 110 against degradation from sunlight. The ultraviolet resistant material can be a separate coating on top of the photothermal coating or the UV resistant material can be mixed in with the photothermal material.

In some implementations, the coating can include a hydrophobic material. The hydrophobic material can be used if salt crystallization is a harmful byproduct. For example, if the device 102 is used to enhance evaporation without collection of precipitated salt, a hydrophobic layer would prevent salt from accumulating over the surface while water vapor can evaporate. The hydrophobic coating can either be added separately (below or on top of the thermal layer) or mixed with the photothermal particles as one-layer during fabrication.

Returning to FIG. 1, the interfacial evaporation device 102 includes a wick 112. An end of the wick 112 is attached to the membrane 110. The body of the wick 112 passes through the member 108 and extends into the water 106 such that an opposite end of the wick 112 resides close to the bottom of the evaporation pond 100. The wick 112 is attached to the member 108. In some implementations, the end of the wick 112 contacts the floating member 108 such that either the floating member 108 is above the wick 112 or the floating member 108 and the contacting end of the wick 112 and the floating member 108 are coplanar. In some implementations, the end of the wick 112 can protrude above the floating member 108. In some implementations, the wick 112, membrane 110 and the floating member 108 can be connected through threaded strings. The wick 112 can be made of a hydrophilic material to absorb water to itself.

In operation, the wick 112 contacts the water 106 in the evaporation pond 100. Due to its hydrophilic nature, the wick 112 draws the water 106 towards itself and direct the drawn water to the membrane 110 through the member 108. The membrane 110 absorbs the water from the wick 112. The absorbed water spreads to the exposed surface area of the membrane 110. As described above, the membrane 110 also absorbs sunlight, converts the sunlight into thermal energy, and uses the thermal energy to evaporate the water absorbed by the membrane 110. The evaporated water leaves behind contaminants carried by the water on the surface of the membrane 110. In this manner, the contaminants are concentrated by the interfacial evaporation device 102. In some implementations, one or more sensors 114 can be deployed as part of (e.g., attached to) the interfacial evaporation device 102. The sensors 114 can monitor a water level in the pond. Alternatively or in addition, the sensors 114 can monitor an evaporation level of the interfacial evaporation device 102. The sensors 114 can transmit monitored values to a controller (not shown) from which the monitored values can be retrieved.

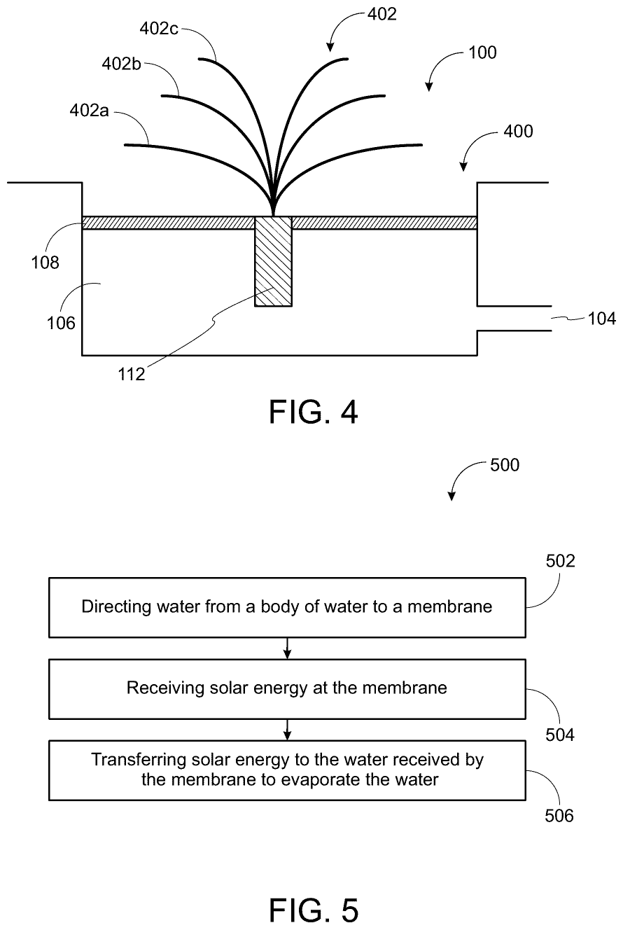

FIG. 4 is a schematic diagram of an evaporation pond deploying another implementation of an interfacial evaporation device 400. Like the interfacial evaporation device 102, the interfacial evaporation device 400 can also be deployed in the evaporation pond 100. The interfacial evaporation device 400 can include the member 108 and the wick 112. In place of the membrane 110 (FIG. 1), the interfacial evaporation device 400 can include a modified membrane 402. The modified membrane 402 includes multiple tubes (e.g., tubes 402a, 402b, 402c), each of which has the same properties of the membrane 110 (FIG. 1). One end of each of the tubes is connected to an end of the wick 112. The other end of each of the tubes extends away from the surface of the member 108. Each tube can be porous or a composite of materials. Each tube can include dense and hollow fiber or threads that can be made of polymeric materials, plastics, fabrics, paper or a combination of them. A hollow fiber can be an elongate tube that is hollow in the middle. A thread can be a solid elongate tube without an internal hollow portion. The tube can also be made of porous inorganic membranes such as ceramics or metal membranes. Each tube has a length that is vertical relative to the member 108 and a strength to limit bending due to wind. The length and diameter of the tube is also selected such that a surface area of a shadow of the tube at different times of the day on the member 108 is minimized. In some implementations, instead of an elongate tubular design, the modified membrane 402 can include multiple sheets (e.g., hollow or solid, having planar geometry with polygonal cross-section such as triangular, rectangular, etc.) having similar properties as each of the tubes 402a, 402b, 402c.

In the schematic shown in FIG. 1, a single membrane 110 that covers the entire member 108 is shown and described. A single wick 112 passes through the member 108 to connect to the single membrane 112. In contrast, in the schematic shown in FIG. 4, the single wick 112 passes through the member 108 to connect to ends of multiple membranes. Other constructions are also possible. For example, in place of a single wick, multiple wicks can be deployed at multiple locations along the surface of the member 108. The member 108 can define multiple openings through which respective, multiple wicks can be passed. The ends of each of the multiple wicks can be attached to the single membrane 112. In another design, all of the multiple wicks can pass through the same opening in the member 108 to attach to the membrane 112. In a further design, all of the multiple wicks can pass through the same opening in the member 108 to attach to ends of multiple tubular membranes such as those shown in FIG. 4.

FIG. 5 is a flowchart of an example of a process 500 of using an interfacial evaporation device in an evaporation pond. At 502, water from a body of water (e.g., an evaporation pond) is directed by a wick to a membrane disposed on a non-submerged surface of a hydrophobic member floating at a surface of the body of water. The wick extends through the hydrophobic member and connects to the membrane. At 504, solar energy is received by the membrane at an evaporation surface of the membrane. At 506, at least a portion of the received solar energy is transferred to the water directed by the wick from the body of water to the membrane. The solar energy evaporates at least a portion of the water. In doing so, contaminants in the water can be concentrated on the membrane surface.

Any implementation of the interfacial evaporation device described here can be integrated with other floating devices such as solar panels or wind turbines to drive evaporation. For example, in place of mechanical evaporators that use moving parts and require energy to be driven, the interfacial evaporation device described here can passively drive evaporation with minimal or no energy consumption.

### EXAMPLES

Certain aspects of the subject matter described here can be implemented as a device for interfacial water evaporation of a body of water. The device includes a floating hydrophobic member configured to float at a surface of the body of water. A membrane is disposed on a surface of the floating hydrophobic member. The membrane defines an evaporation surface of the device for receiving solar energy. A wick is connected to the membrane and extends through the floating hydrophobic member. The wick is configured to extend into the body of water and draw water from the body of water and direct the drawn water to the membrane. The membrane is configured to transfer at least a portion of the received solar energy to the drawn water directed to the membrane by the wick to evaporate the drawn water, thereby decreasing a water content of the body of water.

An aspect combinable with any other aspect includes the following features. The wick and the membrane are hydrophilic.

An aspect combinable with any other aspect includes the following features The floating hydrophobic member is made of a hydrophobic insulating material configured to focus retrieval of solar energy onto the membrane while preventing a majority of the solar energy received by the membrane from being transferred through the floating hydrophobic member to the body of water.

An aspect combinable with any other aspect includes the following features. The membrane is at least partially coated with a hydrophobic coating.

An aspect combinable with any other aspect includes the following features. The membrane is at least partially coated with an ultraviolet-resistant coating.

An aspect combinable with any other aspect includes the following features. The membrane includes a hydrophilic membrane, a Janus membrane, a photothermal membrane, an omniphobic membrane or an oleophobic membrane.

An aspect combinable with any other aspect includes the following features. The membrane includes a planar membrane or a tubular membrane.

An aspect combinable with any other aspect includes the following features. The device includes a sensor configured to monitor a water level of the body of water.

An aspect combinable with any other aspect includes the following features. The membrane is at least partially coated with a photothermal material including carbon, a metal, a metal oxide, a polymer or any combinations thereof.

An aspect combinable with any other aspect includes the following features. The membrane includes a micro-patterned surface.

An aspect combinable with any other aspect includes the following features. The micro-patterned surface defines a surface area sufficient for a flux of 0.5 kg/m²/h. The flux is an evaporation rate of water from the body of water expressed as area-normalized flow rate.

Certain aspects of the subject matter described here can be implemented as a method for interfacial water evaporation of a body of water. A wick directs water from a body of water to a membrane disposed on a non-submerged surface of a hydrophobic member floating at a surface of the body of water. The wick extends through the hydrophobic member and connects to the membrane. The membrane receives solar energy at an evaporation surface of the membrane. The membrane transfers at least a portion of the received solar energy to the water directed by the wick from the body of water to the membrane, thereby evaporating at least a portion of the water.

An aspect combinable with any other aspect includes the following features. The hydrophobic member includes an insulating material. The hydrophobic member prevents a majority of the solar energy received by the membrane from being transferred through the hydrophobic member to the body of water.

An aspect combinable with any other aspect includes the following features. The membrane is at least partially coated with a hydrophobic coating, an ultraviolet-resistant coating, a photothermal material, or any combinations thereof.

An aspect combinable with any other aspect includes the following features. A water level of the body of water is monitored.

An aspect combinable with any other aspect includes the following features. The micro-patterned surface defines a surface area sufficient for a flux of 0.5 kg/m²/h. The flux is an evaporation rate of water from the body of water expressed as area-normalized flow rate.

Certain aspects of the subject matter described here can be implemented as a system for interfacial water evaporation. The system includes a body of water including produced water that has been extracted from a well formed in a subterranean formation. The system includes an interfacial evaporation device. The device includes a floating hydrophobic member configured to float at a surface of the body of water. A membrane is disposed on a surface of the floating hydrophobic member. The membrane defines an evaporation surface of the device for receiving solar energy. A wick is connected to the membrane and extends through the floating hydrophobic member. The wick is configured to extend into the body of water and draw water from the body of water and direct the drawn water to the membrane. The membrane is configured to transfer at least a portion of the received solar energy to the drawn water directed to the membrane by the wick to evaporate the drawn water, thereby decreasing a water content of the body of water.

An aspect combinable with any other aspect includes the following features. The floating hydrophobic member is made of a hydrophobic insulating material configured to focus retrieval of solar energy onto the membrane while preventing a majority of the solar energy received by the membrane from being transferred through the floating hydrophobic member to the body of water.

An aspect combinable with any other aspect includes the following features. The membrane is at least partially coated with a hydrophobic coating, an ultraviolet-resistant coating, a photothermal material, or any combinations thereof.

An aspect combinable with any other aspect includes the following features. The micro-patterned surface defines a surface area sufficient for a flux of 0.5 kg/m²/h. The flux is an evaporation rate of water from the body of water expressed as area-normalized flow rate.

Particular implementations of the subject matter have been described. Other implementations, alterations, and permutations of the described implementations are within the scope of the following claims as will be apparent to those skilled in the art.

1. A device for interfacial water evaporation of a body of water, the device comprising:
a floating hydrophobic member configured to float at a surface of the body of water;
a membrane disposed on a surface of the floating hydrophobic member, wherein the membrane defines an evaporation surface of the device for receiving solar energy; and
a wick connected to the membrane and extending through the floating hydrophobic member, wherein the wick is configured to extend into the body of water and draw water from the body of water and direct the drawn water to the membrane, wherein the membrane is configured to transfer at least a portion of the received solar energy to the drawn water directed to the membrane by the wick to evaporate the drawn water, thereby decreasing a water content of the body of water.

2. The device of claim 1, wherein the wick and the membrane are hydrophilic.

3. The device of claim 2, wherein the floating hydrophobic member is made of a hydrophobic insulating material configured to focus retrieval of solar energy onto the membrane while preventing a majority of the solar energy received by the membrane from being transferred through the floating hydrophobic member to the body of water.

4. The device of claim 3, wherein the membrane is at least partially coated with a hydrophobic coating.

5. The device of claim 3, wherein the membrane is at least partially coated with an ultraviolet-resistant coating.

6. The device of claim 3, wherein the membrane comprises a hydrophilic membrane, a Janus membrane, a photothermal membrane, an omniphobic membrane, or an oleophobic membrane.

7. The device of claim 3, wherein the membrane comprises a planar membrane or a tubular membrane.

8. The device of claim 3, wherein the device comprises a sensor configured to monitor a water level of the body of water.

9. The device of claim 3, wherein the membrane is at least partially coated with a photothermal material comprising carbon, a metal, a metal oxide, a polymer, or any combinations thereof.

10. The device of claim 9, wherein the membrane comprises a micro-patterned surface.

11. The device of claim 10, wherein the micro-patterned surface defines a surface area sufficient for a flux of 0.5 kg/m²/h, wherein the flux is an evaporation rate of water from the body of water expressed as area-normalized flow rate.

12. A method for interfacial water evaporation of a body of water, the method comprising:
directing, by a wick, water from a body of water to a membrane disposed on a non-submerged surface of a hydrophobic member floating at a surface of the body of water, wherein the wick extends through the hydrophobic member and connects to the membrane;
receiving, by the membrane, solar energy at an evaporation surface of the membrane; and
transferring, by the membrane, at least a portion of the received solar energy to the water directed by the wick from the body of water to the membrane, thereby evaporating at least a portion of the water.

13. The method of claim 12, wherein the hydrophobic member comprises an insulating material, and the method comprises preventing, by the hydrophobic member, a majority of the solar energy received by the membrane from being transferred through the hydrophobic member to the body of water.

14. The method of claim 13, wherein the membrane is at least partially coated with a hydrophobic coating, an ultraviolet-resistant coating, a photothermal material, or any combinations thereof.

15. The method of claim 14, comprising monitoring a water level of the body of water.

16. The method of claim 15, wherein the membrane comprises a micro-patterned surface, wherein the micro-patterned surface defines a surface area sufficient for a flux of 0.5 kg/m²/h, wherein the flux is an evaporation rate of water from the body of water expressed as area-normalized flow rate.

17. A system for interfacial water evaporation, the system comprising:
a body of water comprising produced water that has been extracted from a well formed in a subterranean formation; and
a device comprising:
a floating hydrophobic member configured to float at a surface of the body of water;
a membrane disposed on a surface of the floating hydrophobic member, wherein the membrane defines an evaporation surface of the device for receiving solar energy; and
a wick connected to the membrane and extending through the floating hydrophobic member, wherein the wick is configured to extend into the body of water and draw water from the body of water and direct the drawn water to the membrane, wherein the membrane is configured to transfer at least a portion of the received solar energy to the drawn water directed to the membrane by the wick to evaporate the drawn water, thereby decreasing a water content of the body of water.

18. The system of claim 17, wherein the floating hydrophobic member is made of a hydrophobic insulating material configured to focus retrieval of solar energy onto the membrane while preventing a majority of the solar energy received by the membrane from being transferred through the floating hydrophobic member to the body of water.

19. The system of claim 18, wherein the membrane is at least partially coated with a hydrophobic coating, an ultraviolet-resistant coating, a photothermal material, or any combinations thereof.

20. The system of claim 19, wherein the membrane comprises a micro-patterned surface, wherein the micro-patterned surface defines a surface area sufficient for a flux of 0.5 kg/m²/h, wherein the flux is an evaporation rate of water from the body of water expressed as area-normalized flow rate.
